(19) United States
(12) Patent Application Publication
(10) Pub. No.: US 2020/0265482 A1
(43) Pub. Date: Aug. 20, 2020

(54) METHOD AND SYSTEM FOR ENABLING SOCIAL MEDIA BASED CROWD-SOURCED FUNDING

(71) Applicant: Advocato, LLC, McLean, VA (US)

(72) Inventors: Joseph Alexander MACKOUL, Washington, DC (US); Charles Buckley GILLOCK, JR., Nashville, TN (US); Sara Allison NEEL, Madison, WI (US); Jared Cole BAUM, Madison, WI (US)

(73) Assignee: Advocato, LLC, McLean, VA (US)

(21) Appl. No.: 16/790,883

(22) Filed: Feb. 14, 2020

Related U.S. Application Data
(60) Provisional application No. 62/806,470, filed on Feb. 15, 2019.

(51) Int. Cl. G06Q 30/02; G06Q 30/08; G06Q 40/02; G06Q 10/10; G06Q 50/00; G07C 13/00

(52) U.S. Cl. CPC G06Q 30/0279; G06Q 30/08; G06Q 40/02; G06F 16/9536; G06Q 50/01; G07C 13/00; G06Q 10/103

(57) ABSTRACT

A method for establishing an advocacy campaign with a service provider through crowdfunding includes: receiving a campaign request including advocacy goals; receiving a plurality of service provider bids, each including a minimum funding amount and project description; receiving a plurality of funding pledges, each from one of a plurality of users and including a pledged monetary amount, wherein a total of the pledged monetary amount included in the funding pledges meets or exceeds a predetermined amount before a predetermined period of time; distributing the minimum funding amount and project description for each service provider bid to each of the users; receiving a plurality of votes, each indicating one of the service provider bids; and assigning the campaign request to a winning bid of the service provider bids based on a number of the plurality of votes indicating the winning bid.

### FIELD

The present disclosure relates to processing, analyzing, and distributing, and otherwise controlling, data that establishes a professional services (e.g., advocacy) or other similar type of campaign through crowdfunding, specifically enabling multiple potential service providers to bid on a campaign desired by one or many users that crowdfund the campaign, where the users select the service provider used to run the campaign.

### BACKGROUND

In a more connected world, individuals are becoming more and more interested in advocacy and other group and community based endeavors. As advocacy projects gain more and more attention and traction in the news, and it becomes easier for people to bring awareness to advocacy projects and campaigns, othcr individuals that had not previously been involved in advocacy become interested. However, many interested people lack the knowledge and ability to start an advocacy project, get in touch with others that are interested in the same advocacy, or to find any entity that may be able to assist them with their advocacy. In an Internet enabled world, it is not the lack of information that is the problem, but rather the overwhelming amount of information. Further, in many cases, such campaigns may cost tens, if not hundreds of thousands of dollars, which is often infeasible for the average interested party.

Some methods have been developed to attempt to provide a platform for individuals to request advocacy on their behalf to be performed. However, these platforms often lack transparency and offer users little more than an ability to request advocacy with little-to-no control over which entity may take up the campaign, if a cause may even be fought for, or if it will perform as expected. These other platforms do not present the information in a form that can be comprehended by a casual but interested party. To help gain support and fund these campaigns, these platforms often rely on crowdfunding, which involves having additional users pledge money that can be spent in furtherance of the campaign. However, the lack of transparency and user control over the campaign has been prohibitive to the success of such platforms. Further still, while in some crowd-sourcing platforms are open to anyone who wishes to start one, that person may not have the ability to carry through or find the right resources needed for success.

Thus, there is a need for a technical system that enforces transparency and maintains community control over how an advocacy campaign is started.

### SUMMARY

The present disclosure provides a description of systems and methods for establishing an advocacy campaign with a service provider through crowdfunding. A web-based platform enables an individual to submit and idea for which they want a professional service (or any other suitable type) campaign to be conducted, such as a new public works project or a change in laws or regulations or other efforts. The idea can be viewed and contributed to by other users, who may pledge monetary assistance to the campaign. Rather than the campaign be randomly assigned to a service provider or run by the originator, any potential service provider has the ability to design their own plan for carrying out the campaign and submits their bid into the system. The users that contributed (including those that have pleaded to contribute) to the campaign are able to vote on the proposals and select the service provider to whom the campaign will be awarded. As a result, the individual users that want the campaign to happen maintain control over how the campaign will be carried out. The platform also provides and encourages service providers to provide regular updates and information, maintaining the transparency and the ability for individuals to influence the course of the campaign. The result is stronger, more meaningful and trustworthy, crowdfunded community-based advocacy and campaigning.

A method for establishing an advocacy campaign with a service provider through crowdfunding includes: receiving, by a receiver of a processing server, a campaign request, wherein the campaign request includes at least one or more advocacy goals; receiving, by the receiver of the processing server, a plurality of service provider bids, where each bid includes at least a minimum funding amount and a project description; receiving, by the receiver of the processing server, a plurality of funding pledges, each being associated with one of a plurality of users and includes at least a pledged monetary amount, wherein a total of the pledged monetary amount included in the received plurality of funding pledges meets or exceeds a predetermined amount before a predetermined period of time; distributing, by a transmitter of the processing server, at least the minimum funding amount and project description for each of the plurality of service provider bids to each of the plurality of users; receiving, by the receiver of the processing server, a plurality of votes, where each vote indicates one of the plurality of service provider bids; and assigning, by a processing device of the processing server, the campaign request to a winning bid of the plurality of service provider bids based on a number of the plurality of votes indicating the winning bid.

A system for establishing an advocacy campaign with a service provider through crowdfunding includes: a processing device of a processing server; a receiver of the processing server configured to receive a campaign request, wherein the campaign request includes at least one or more advocacy goals, receive a plurality of service provider bids, where each bid includes at least a minimum funding amount and a project description, and receive a plurality of funding pledges, each being associated with one of a plurality of users and includes at least a pledged monetary amount, wherein a total of the pledged monetary amount included in the received plurality of funding pledges meets or exceeds a predetermined amount before a predetermined period of time; and a transmitter of the processing server configured to transmit at least the minimum funding amount and project description for each of the plurality of service provider bids to each of the plurality of users, wherein the receiver of the processing server is further configured to receive a plurality of votes, where each vote indicates one of the plurality of service provider bids, and the processing device of the processing server is configured to assign the campaign request to a winning bid of the plurality of service provider bids based on a number of the plurality of votes indicating the winning bid.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for establishing an advocacy campaign through crowdfunding in accordance with exemplary embodiments.

FIG. 2 is a block diagram illustrating the processing server of the system of FIG. 1 for providing a platform to enable crowdfunding of an advocacy campaign in accordance with exemplary embodiments.

FIG. 3 is a flow diagram illustrating a process for the creation and awarding of an advocacy campaign through crowdfunding in the system of FIG. 1 in accordance with exemplary embodiments.

FIG. 4 is a flow chart illustrating an exemplary method for establishing an advocacy campaign with a service provider through crowdfunding in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Establishing an Advocacy Campaign Through Crowdfunding

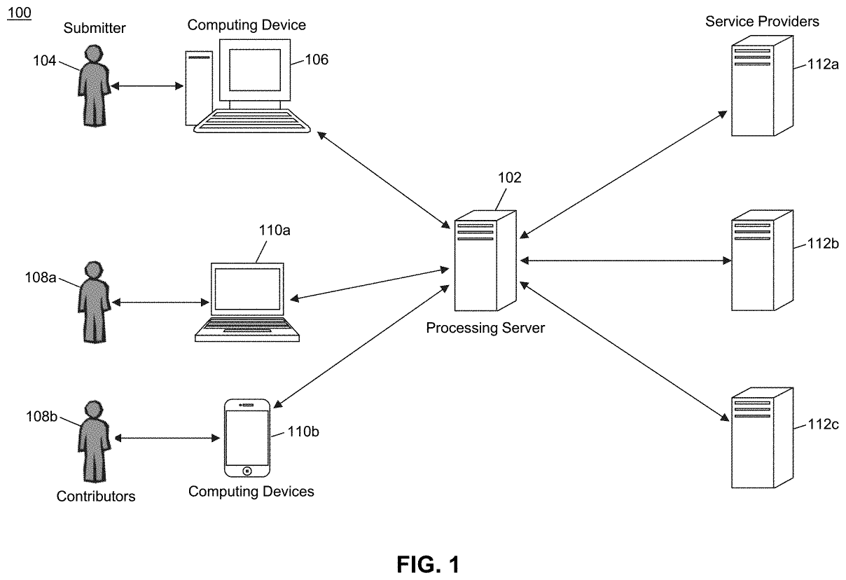

FIG. 1 illustrates a system 100 for establishing an advocacy campaign through a platform that enables individuals to crowdfund and select a suitable service provider for carrying out the advocacy campaign based on submitted bids. As discussed herein, “advocacy campaign” may refer to any type of campaign that may be carried out by a third party on behalf of individual users that crowdfund the campaign, including any campaign that may be traditionally considered to be “advocacy” or other types of potential campaigns.

The system 100 may include a processing server 102. The processing server 102, discussed in more detail below, may be configured to provide a platform to users for the creation of an advocacy campaign that is awarded to one of a plurality of bidding service providers based on the selection of users that crowdfund the campaign. In the system 100, a submitter 104 may submit a request for a campaign to the processing server 102. In an exemplary embodiment, the processing server 102 may provide a web-based platform or an application program that may be accessed by the submitter 104 using a computing device 106 for use in submitting the campaign request. The computing device 106 may be any type of computing device suitable for performing the functions discussed herein, such as a desktop computer, laptop computer, notebook computer, tablet computer, cellular phone, smart phone, smart watch, smart television, wearable computing device, etc. The computing device 106 may communicate with the processing server 102 using any suitable communication network and method, which may be dependent on the medium used by the platform.

The submitter 104 may submit their campaign request, which may include one or more advocacy goals that the submitter 104 wants the campaign to accomplish. Advocacy goals may include budget goals, time goals, objectives that must be accomplished, levels of awareness, outreach requirements, etc. For instance, a submitter 104 may request a campaign to have a law repealed, where a sole advocacy goal may be repeal of the law, or may include additional advocacy goals regarding times and intermediate objectives, such as to have the law repealed by a desired date and a specified number of supporting congress members by particular dates. In another example, a submitter 104 may request a campaign to have a new park built in their city, with goals regarding approval of the city by a specific date, selection of a contractor by a specific date, requirements for the contractor, requirements for the park, etc. In some cases, the submitter 104 may set forth a minimum funding amount that the campaign must receive before it can be carried out.

The processing server 102 may receive the campaign request from the submitter 104 and may add a request for the campaign to its platform. The platform and potential campaigns may be viewable by any users of the platform. For instance, any user that visits the web page for the platform or downloads an application program for the platform may be able to view campaigns that require funding. In some instances, the platform may provide the opportunity to highlight the campaign, such as by enabling the submitter 104 or another entity to “sponsor” the campaign, bringing extra attention to the campaign for users using any suitable techniques. As part of the viewing of the requested campaign, the users may be able to view the one or more advocacy goals set by the submitter 104.

Users may view the requested campaign and may decide that they want to contribute to the requested campaign. Such users may become contributors 108, illustrated in FIG. 1 as contributors 108a and 108b, by pledging a monetary amount to the campaign. Contributors 108 may interact with the processing server 102 using their own computing devices 110, which may be the same type of device as the computing device 106 or any other suitable type of computing device. In some cases, the monetary amount must be above a minimum amount, which may be set by the platform or by the submitter 104. In some instances, the contributor 108 may pledge the amount, but may not be required to pay the amount unless the campaign gets successfully funded and awarded. In other instances, the contributor 108 may pay the amount immediately, but may be refunded for their contribution of the campaign does not get funded or awarded. In cases where the amount is not immediately paid, the contributor 108 may provide the processing server 102 with financial information when making the pledge, that may be used by the processing server 102 to initiate a payment transaction for collection of the pledge at a later time (e.g., when the minimum funding amount has been reached, the campaign has been awarded, etc.).

As contributors 108 pledge contributions to the requested campaign, the processing server 102 may update the current funding amount of the campaign to reflect the contributions. As a result, users viewing the requested campaign may see the progress of the attempted funding of the requested campaign. In some cases, users may be able to provide feedback to the campaign and/or the submitter 104 of the campaign. For instance, a user may suggest that the advocacy goals be changed, added to, removed, etc. Such feedback may be used by the submitter 104 (e.g., or a user or contributor 108 authorized by the submitter 104) to adjust the advocacy goals or other information of the campaign. For example, the submitter 104 may be unfamiliar with detailed information about carrying out their desired campaign, and may be assisted by contributors 108 with more experience in the space, and may use that assistance to strengthen the campaign and/or select more realistic advocacy goals. In some embodiments, only contributors 108 may be able to provide feedback for a requested campaign.

While users continue to view and contribute to the requested campaign, a plurality of different service providers 112, illustrated in FIG. 1 as service providers 112a, 112b, and 112c may be able to view the requested campaign. Any service provider 112 that is interested in taking up the campaign may be able to submit a bid for the campaign to the processing server 102. In some cases, a service provider 112 may be required to register with the processing server 102 before bidding on a campaign. In some such cases, the processing server 102 (e.g., or an entity associated therewith and/or in operation thereof) may perform a vetting process to determine if the service provider 112 is capable of fulfilling an advocacy campaign, such as to prevent fraud or low chances of success.

When a service provider 112 is interested in taking up a campaign, they may compile a proposal for carrying out the campaign. The proposal may include an overall strategy for reaching the goals of the campaign as indicated by the campaign creator, such as plans for each of the one or more advocacy goals, which media outlets they intend to engage, any web presence or coalition they intend to operate or coalesce on behalf of the campaign, budget estimates and requirements, personnel information, etc. The service provider 112 may submit their proposal to the processing server 102. The processing server 102 may make submitted proposals available for viewing by the submitter 104. In some cases, proposals may be viewable by all users of the platform. In other cases, only contributors 108 to a requested campaign may be allowed to view proposals submitted by service providers 112 for that campaign. In some instances, proposals may only be viewable once the minimum funding amount for a campaign has been reached. In some embodiments, proposals submitted by service providers 112 may be used to adjust the minimum funding amount. For example, if a majority of proposals require a minimum budget that is below the minimum funding amount, then the minimum funding amount may be lowered to provide for easier successful awarding of the campaign. In cases where proposals may require a minimum budget above the minimum funding amount, the minimum funding amount may be increased or a proposal may not be awarded unless the contributed amount to the requested campaign reaches the minimum budget for that proposal.

Once a minimum funding amount has been reached through contributions, users may vote on a proposal to select a service provider 112 to carry out the campaign. In some cases, the submitter 104 may set a period of time during which bids may be submitted by service providers 112 and after which the vote may occur. In some embodiments, a requested campaign may be required to reach the minimum funding amount within a predetermined period of time. In such embodiments, the predetermined period of time may be set by the submitter 104 or by the processing server 102 as part of the platform. In some cases, there may be multiple funding goals and respective time periods set before a vote may be conducted for a requested campaign. For example, a campaign that needs to raise $1,000,000 may be required to reach $100,000 in contributions by a first date, $500,000 in contributions by a second date, and the $1,000,000 minimum funding amount by a third date. In other cases, a submitter 104 may set the monthly funding amount for the campaign from a drop-down menu of pre-set retainer levels. In this case, the campaign accepts proposals from service provider 112 as soon as the campaign reaches enough funding for one month's goal.

To vote on a proposal, users may be able to view each of the proposals submitted by service providers 112 for a campaign. In some cases, only contributors 108 and the submitter 104 may be eligible to vote for a proposal for a requested campaign. The processing server 102 may collect all votes and may select a proposal for which the campaign will be awarded to the corresponding service provider 112. In some embodiments, each user (e.g., contributor 108) may be given a single vote to cast for a proposal. In other cases, users may receive votes based on the amount of their contribution to the requested campaign. For instance, a contributor 108 may receive one vote per dollar (e.g., or other currency unit). In some cases, a contributor 108 may be required to cast all of the votes for a single proposal, or may be able to vote on multiple proposals. In some instances, a contributor 108 may be allowed to cast votes against a particular proposal. In some embodiments, live voting results may be displayed to users, such as to provide users with information regarding how the vote is progressing. In other embodiments, no results may be shown until a proposal is selected. In some embodiments, votes may be granted to users based on donations on a marginally decreasing scale as to not allow any 1 user to dominate.

In some cases, a predetermined period of time may be set for voting. In such cases, the votes may be counted after the expiration of the predetermined period of time. In some instances, a minimum number (e.g., percentage) of votes must be received before a proposal may be selected, such as requiring a majority or supermajority of votes having been cast. In some cases, the minimum number of votes must be received by a predetermined period of time. For instance, a proposal may only be selected after a one-week voting period, and only once 66% of votes have been cast, where voting may remain open after the one-week voting period until the 66% requirement of votes have been met.

The processing server 102 may select a proposal that will be awarded based on the votes. The processing server 102 may inform the submitter 104, the contributors 108, and the service providers 112 of the winning proposal. The service provider 112 that submitted the winning proposal may then be provided with the funding contributed for the campaign and may execute the campaign to carry out the advocacy requested by the submitter 104. In some cases, the service provider 112 may be provided with all of the funding at once. In other cases, the funding may be provided periodically (e.g., weekly, monthly, etc., which may be set by the submitter 104, in the proposal, by the processing server 102, etc.). In such cases, the processing server 102 may collect all contributions immediately (e.g., if not already done when the pledge first occurred) and may only distribute the periodic funding as the periods occur. In some embodiments, the service provider 112 may receive the funding in increments, such as based on completion of advocacy goals or as awarded by the submitter 104 and/or through contributor votes. For instance, the service provider 112 may be required to show results or provide information to the contributors 108 regarding their work on the campaign to receive additional funds. In some cases, additional contributions can be made even after awarding of the campaign to the selected service provider 112. In some instances, the service provider 112 may be provided with an initial payment, with ongoing payments being made following the initial payment, such as an initial retainer amount being paid with monthly, ongoing funding subsequently provided.

In some embodiments, the service provider 112 may be encouraged, or required, to provide regular updates regarding the carrying out of a campaign to the processing server 112. In such embodiments, the updates may be available to all users, or to the submitter 104 and contributors 108, or a combination thereof. For example, some overall updates may be broadcast to all users, while detailed information may be made available only to contributors 108. In some embodiments, the processing server 102 may use a clipping service, web crawlers, or other tools and entities to collect information regarding the carrying out of an awarded campaign. In such embodiments, the collected information may be made available to contributors 108, or to all users, as applicable, to further increase the transparency regarding success of the campaign.

In some embodiments, a service provider 112 may lose a campaign if requirements are not met by the performance of the service provider 112 or if the submitter 104 and/or contributors 108 are not satisfied by the performance. In such instances, any funding provided to the service provider 112 on an ongoing basis, and/or any funding not already used (e.g., any remainder from an initial retainer payment) may be stopped and refunded, if applicable. In cases where a refund is made, the submitter 104 and/or contributors 108 may be refunded by the platform in accordance with the payments made. In some instances, the removal of a service provider 112 from the campaign may result in ending of the campaign entirely, requiring submission of a new campaign by the submitter 104. In other instances, the submitter 104 may have the option of initiating a new vote for a new service provider 112 to take over the campaign. In some cases, service providers 112 may be requested to submit new proposals due to any change in circumstances as a result of the actions performed by the initial service provider 112 prior to loss of the campaign. In some embodiments, a campaign may be re-submitted or restarted even in cases where a service provider 112 may complete their proposal.

In some cases, users may be able to provide feedback regarding service providers 112, such as by providing ratings regarding a service provider. In some instances, feedback may be made in the form of a single rating. In other instances, users may provide feedback of specific criteria. For instance, contributors 108 may provide ratings for a service provider's adherence to budget, communication with contributors, quality of work, timeliness, and an overall rating. In such cases, the feedback information and ratings for a service provider 112 may be viewable by users when voting on proposals submitted by the service provider 112 for other requested campaigns. This may provide additional incentives for service providers 112 to be prudent in their transparency and sharing of information with contributors 108 and other users. In some instances, only contributors 108 to a campaign that is awarded to a service provider 112 may be able to rate that service provider 112. In some cases, ratings may be tied to specific campaigns. For example, contributors 108 may be able to view the ratings for a service provider 112 for each campaign, which may be accompanied by an overall (e.g., average, median, etc.) rating. In an example, a service provider 112 may receive bad ratings for a campaign for repealing a law, but have several good ratings for campaigns to build infrastructure improvements, which may assist the contributors 108 in selecting a proposal accordingly.

In some cases, ownership of a campaign submitted by the submitter 104 may be retained by the submitter. In other cases, ownership may be provided to the processing server 102 (e.g., to an entity in ownership thereof) when a campaign is submitted to the platform. In some instances, a service provider 112 whose bid is accepted may be provided ownership of a campaign upon selection of the service provider 112. In some embodiments, a submitter 104 may be provided with options regarding campaign ownership as part of the submission process of the campaign.

In some embodiments, the processing server 102 may be configured to combine multiple campaigns together. For instance, in cases where a first submitter 104 submits a campaign and a second submitter 104 submits a different campaign with the same or a similar objective, the campaigns may be combined together to provide for more focused and effective crowdfunding. In some cases, the submitters 104 of campaigns that are matched may be prompted to provide approval for combination of their campaign with another. In some instances, submitters 104 whose campaigns are combined may be positioned as co-submitters for the combined campaign. In other instances, one of the submitters 104 may be selected (e.g., by all eligible submitters, by the processing server 102, by existing contributors 108, etc.) as the submitter 104 for the combined campaign.

In some embodiments, the processing server 102 may be configured to vet newly submitted campaigns and/or proposals submitted for available campaigns. In such embodiments, the processing server 102 may evaluate a campaign or proposal for compliance with rules, regulations, terms and conditions, terms of service, etc. of the processing server 102, and may also evaluate for compliance with any applicable rules, laws, regulations, etc. of any agency that may have jurisdiction over the submitter 104, processing server 102, contributors 108, campaign, etc. For example, the processing server 102 may prohibit any campaign whose goal is illegal in a jurisdiction where the campaign is to take place.

The methods and systems discussed herein enable the crowdfunding of an advocacy campaign where a service provider is selected by the individual users of the system, and where the system is designed to maximize transparency and user control and/or influence of carrying out the campaign. By enabling users to vote on which service provider 112 is selected, the users that are financially supporting the campaign are provided with the most control over how the campaign is carried out. In cases where feedback can also be provided, service providers 112 become greatly encouraged to provide additional transparency as to the carrying out of the campaign during the process, strengthening the position of contributors 108 even more. As a result, a submitter 104 may be able to have a campaign successfully funded and carried out through the platform of the processing server 102 with no personal ability to fund the campaign or knowledge as to how it may be completed.

### Processing Server

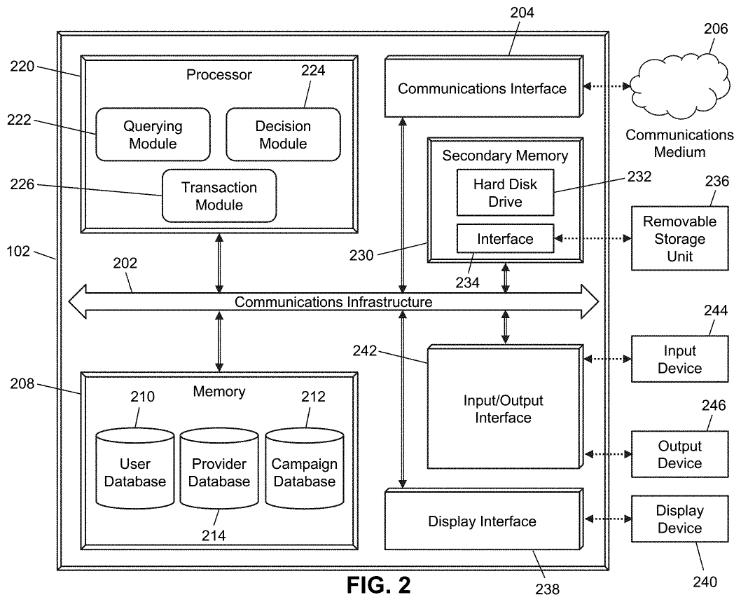

FIG. 2 illustrates an embodiment of the processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. It will be apparent to persons having skill in the relevant art that, in some cases, one or more components of the processing server 102 may be stored externally to the processing server 102 and accessible via any suitable communication network and method. For instance, the processing server 102 may utilize cloud computing techniques where data and/or processing power may utilize external sources.

The processing server 102 may include a communications infrastructure 202. The communications infrastructure 202 may be configured to transmit data between modules, engines, databases, memories, and other components of the processing server 102 for use in performing the functions discussed herein. The communications infrastructure 202 may be comprised of one or more communication types and utilize various communication methods for communications within a computing device. For example, the communications infrastructure 202 may be comprised of a bus, contact pin connectors, wires, etc. In some embodiments, the communications infrastructure 202 may also be configured to communicate between internal components of the processing server 102 and external components of the processing server 102, such as externally connected databases, display devices, input devices, etc.

The processing server 102 may also include a communications interface 204. The communications interface 204 may include one or more interfaces used to interact with and facilitate communications between the processing server 102 and one or more external devices via suitable communications mediums 206. For instance, the communications interface 204 may interface with the communications infrastructure 202 and provide an interface 204 for connecting the processing server 102 to one or more communications mediums 204 for the electronic transmission or receipt of data signals that are encoded or otherwise superimposed with data for use in performing the functions discussed herein. Communications interfaces 204 may include universal serial bus (USB) ports, Personal Computer Memory Card International Association (PCMCIA) ports, PS/2 ports, serial ports, fiber optic ports, coaxial ports, twisted-pair cable ports, wireless receivers, etc. Communications mediums 206 may include local area networks, wireless area networks, cellular communication networks, the Internet, radio frequency, Bluetooth, near field communication, etc.

In some instances, the processing server 102 may include multiple communications interfaces 204 for electronically transmitting and receiving data signals via one or more communications mediums 206, such as a first communications interface 204 configured to transmit and receive data signals via a local area network and a second communications interface 204 configured to transmit and receive data signals via the Internet. In some instances, the communications interface 204 may include a parsing module for parsing received data signals to obtain the data superimposed or otherwise encoded thereon. For example, the communications interface 204 may include (e.g., or otherwise have access to, such as via the communications infrastructure 204) a parser program configured to receive and transform the received data signal into usable input for the functions performed by the processing device to carry out the methods and systems described herein.

The communications interface 204 may be configured to establish communication channels with external devices, such as the computing devices 106 and 110 and service providers 112 of FIG. 1. The communication channels may be used to receive campaign requests from computing devices 106, votes transmitted by computing devices 106 and 110, campaign proposals bids from service providers 112, feedback from computing devices 106 and 110, updates to campaign progress from service providers 112, and other communications as discussed herein.

The processing server 102 may also include a memory 208. The memory 208 may be configured to store data for use by the processing server 102 in perform the functions discussed herein. The memory 208 may be comprised of one or more types of memory using one or more suitable types of memory storage, such as random access memory, read-only memory, hard disk drives, solid state drives, magnetic tape storage, etc. In some cases, the memory 208 may be non-transitory computer readable media, which may be configured to store data suitable for execution by the processing server 102 in performing the functions discussed herein. The memory 208 may store data in any suitable type of configuration, such as in one or more lists, databases, tables, etc., which may store the data in a suitable data format and schema. In some instances, the memory 208 may include one or more relational databases, which may utilize structured query language for the storage, identification, modifying, updating, accessing, etc. of structured data sets stored therein.

The memory 208 of the processing server 102 may include a user database 210. The user database 210 may be configured to store a plurality of user profiles using a suitable storage format and schema. Each user profile may be a structured data set configured to store data related to a user of the platform provided by the processing server 102, such as the submitter 104, contributors 108, and other users. Each user profile may be configured to store, for instance, a user identifier, authentication information, submitted campaign requests, account information for contribution payments, voting information, submitted feedback, notification preferences, etc.

The memory 208 of the processing server 102 may also include a campaign database 212. The campaign database 212 may be configured to store a plurality of campaign data entries using a suitable storage format and schema. Each campaign data entry may be a structured data set configured to store data related to a requested campaign. The campaign data entry may include, for instance, a campaign name and description, set advocacy goals, minimum funding amount, current funding amount, a user identifier for the submitter 104, user identifiers and pledge amounts for contributors 108, voting information, received proposals submitted by service providers 112 and associated identifiers, campaign updates, applicable periods of time, etc.

The memory 208 of the processing server 102 may also include a provider database 214. The provider database 214 may be configured to store a plurality of provider profiles using a suitable storage format and schema. Each provider profile may be a structured data set configured to store data related to a service provider 112 registered with the platform that is eligible to submit proposals for requested campaigns. The provider profile may include, for instance, a provider identifier uniquely associated with the service provider, account information for receiving campaign funds, contact information, submitted proposals, awarded campaign information, received user feedback, personnel information, etc.

The memory 208 may also be configured to store program data for application programs to be executed by a processor 220 of the processing server 102, such as program code for the platform, including programming information for a web-based interface or for application programs executed on local computing devices 106 and 110. The memory 208 may also be configured to store algorithms for vote scoring, counting, and weighing, calculation of funding amounts, determination of periods of time, etc. In some cases, the memory 208 may include programming code used to combine submitted campaign requests, such as to match similar campaign requests together for greater chances at success in funding and receipt of proposals. In some cases, matching and combining of campaign requests may be done automatically, or may be approved by the associated submitters 104. The memory 208 may also be configured to store any additional database that may be necessary or suitable for performing the functions discussed herein. For example, the memory 208 may include a separate database to store user, campaign, and/or service provider feedback, databases to keep track of payments made by submitters 104 and contributors 108 and to service providers 112, databases for submitted service provider bids, databases for vote tracking, etc.

The processing server 102 may also include the processor 220. The processor 220 may be configured to perform the functions of the processing server 102 discussed herein as will be apparent to persons having skill in the relevant art. In some embodiments, the processor 220 may include and/or be comprised of a plurality of engines and/or modules specially configured to perform one or more functions of the processing device, such as a querying module 222, decision module 224, transaction module 226, etc. As used herein, the term “module” may be software or hardware particularly programmed to receive an input, perform one or more processes using the input, and provides an output. The input, output, and processes performed by various modules will be apparent to one skilled in the art based upon the present disclosure. The processor 220 as discussed herein may be a single processor, a plurality of processors, or combinations thereof, which may also include processors that may have one or more processor “cores.” Operations performed by the processor 220 or modules included therein may be performed as a sequential process and/or be performed in parallel, concurrently, and/or in a distributed environment. In some embodiments the order of operations may be rearranged without departing from the spirit of the disclosed subject matter. The processor 220 and the modules or engines included therein may be configured to execute program code or programmable logic to perform the functions discussed herein, such as may be stored in the memory 208 and/or a secondary memory 230, discussed in more detail below.

The processor 220 of the processing server 102 may include a querying module 222. The querying module 222 may be configured to execute queries on databases to identify information. The querying module 222 may receive one or more data values or query strings, and may execute a query string based thereon on an indicated database, such as the user database 210, to identify information stored therein. The querying module 222 may then output the identified information to an appropriate engine or module of the processing server 102 as necessary. The querying module 222 may, for example, execute a query on the user database 210 to create a user profile for a new user to the platform or to update a user profile for an existing user.

The processor 220 of the processing server 102 may also include a decision module 224. The decision module 224 may be configured to apply logic, algorithms, and other programming code and considerations to make decisions for the processing server 102 for performing the functions discussed herein. The decision module 224 may receive a request as input, which may be accompanied by data to use in the request, or may be used by the decision module 224 to identify information to be used in the decision. The decision module 224 may then output the result of its decision to another module or engine of the processing server 102. The decision module 224 may be configured to, for instance, make decisions regarding the combination of campaign requests, decide on periods of time and/or funding amounts, decide on winning proposals based on votes, etc.

The processor 220 of the processing server 102 may also include a transaction module 226. The transaction module 226 may be configured to perform functions related to the initiation and processing of payment transactions as part of the collection of contributions from contributors 108 and awarding of campaign funding to selected service providers 112. The transaction module 226 may be configured to maintain storage and protection of account information, submit transactional information to suitable entities and processing systems, operate as a point of sale, etc. In some cases, the transaction module 226 may be configured to maintain accounting for holding accounts on behalf of the processing server 102 or associated entity, such as in cases where contributions are collected prior to all funding being distributed to service providers 112.

In some embodiments, the processing server 102 may also include a secondary memory 230. The secondary memory 230 may be another memory in addition to the memory 208 that may be used to store additional data for use in performing the functions of the processing server 102 as discussed herein. In some embodiments, the secondary memory 230 may be a different format or may use a different data storage method and/or schema than the memory 208. The secondary memory 230 may be any suitable type of memory, and, in some instances, may include multiple types of memory. For instance, the secondary memory 230 may be comprised of a hard disk drive 232 and one or more interfaces 234, where the interfaces 234 are configured to transmit data to and receive data from one or more removable storage units 236. Removable storage units 236 may include, for example, floppy disks, compact discs, digital video discs, Blu-ray discs, removable hard drives, flash drives, universal serial bus drives, etc.

In some cases, the processing server 102 may also include a display interface 238. The display interface may be configured to interface the processing server 102 with one or more display devices 240. The display devices 240 may be devices configure to display data received from the processing server 102. Display devices 240 may be any suitable type of display, including, for example, liquid crystal displays, light emitting diode displays, thin film transistor display, capacitive touch displays, etc. In some instances, the processing server 102 may include one or more display interfaces 238, which may interface with one or more display devices 240.

The processing server 102 may also include an input/output interface 242. The input/output interface 242 may be configured to interface the processing server 102 with one or more input devices 244 and/or output devices 246 for the transmission to and receipt of data from the respective devices. The input/output interface 242 may include any suitable type of interface, and in some instances may include multiple types of interfaces, such as for interfacing with multiple types of input devices 244 and/or output devices 246. Input devices 244 may include any suitable type of device for inputting data to a processing server 102, such as a keyboard, mouse, microphone, camera, touch screen, click wheel, scroll wheel, remote control, etc.

### Process for Establishing an Advocacy Campaign Through Crowdfunding

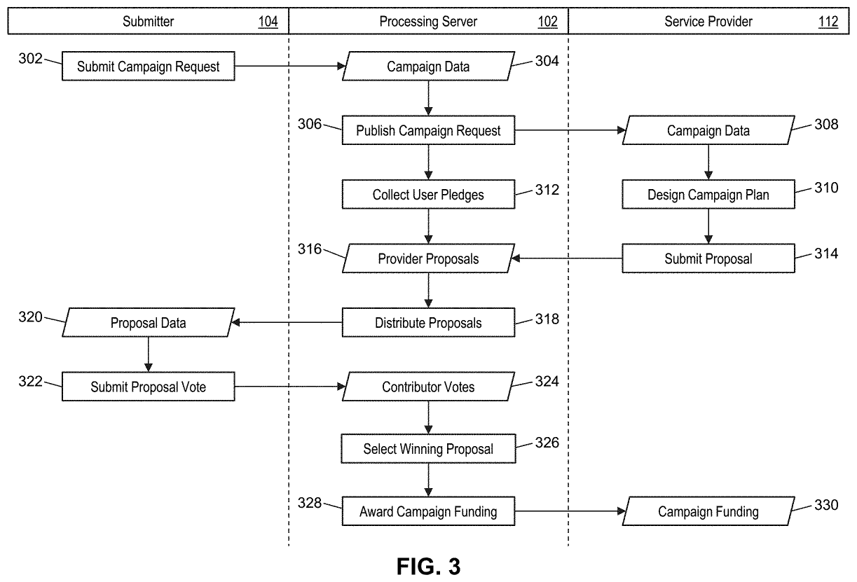

FIG. 3 illustrates a process for the creation and awarding of an advocacy campaign to a service provider 112 in the system 100 following submission by a submitter 104 and crowdfunding through contributors 108.

In step 302, the submitter 104 may submit a campaign request to the processing server 102 using a suitable method, such as through an application program executed on their computing device 106 or via a web-based platform, such as may be access using an application programming interface. In step 304, the processing server 102 may receive (e.g., via the communications interface 204) the campaign request. The campaign request may include at least one or more advocacy goals, and may also include a minimum funding amount, funding period of time, description, title, service provider team members, and other information that may be submitted by the submitter 104. In step 306, the processing server 102 may publish the campaign for viewing by service providers 112 and potential contributors 108. Publishing of the campaign may consist of creating a new campaign profile in the campaign database 212 of the processing server 102 for the campaign and enabling service providers 112 and other users to view the campaign request on the platform.

In step 308, service providers 112 may access the requested campaign using the platform to view the campaign data, such as to view the professional service goals. In step 310, each service provider 112 may design a plan to achieve the one or more professional service goals and otherwise carry out the requested campaign. While service providers are creating proposals, in step 312, the processing server 102 may be receiving contribution pledges from contributors 108 for the requested campaign. The pledges may be submitted by contributors 108 using their associated computing devices 110 and may be pledges to pay a monetary amount (e.g., immediately or following successful funding of the requested campaign) to the service provider 112 that is selected to carry out the campaign.

In step 314, each service provider 112 that wants to bid for the requested campaign may submit their proposal to the processing server 102. In step 316, the processing server 102 may receive (e.g., via the communications interface 204) proposals from a plurality of different service providers 112. Each proposal may include any information that may be requested by the submitter 104 for each proposal to have, and/or may include any information the service provider 112 wants to share regarding their plan to complete the requested campaign, such as budget requirements, timelines, personnel, plans for each advocacy goal, etc.

Once the proposals have been received, and if the requested campaign has received enough pledged contributions to meet the minimum funding amount within the predetermined period of time, then, in step 318, the processing server 102 may make all of the received proposals available to the submitter 104 and other contributors 108 for voting. In step 320, the submitter 104 may receive the data for each of the submitted proposals through the platform, which the submitter 104 may review. The submitter 104 may select one of the proposals that they want to cast their vote(s) for, and, in step 322, may submit a vote for a specific proposal to the processing server 102.

In step 324, the processing server 102 may receive the vote(s) from the submitter 104 and all of the votes from other contributors 108 to the requested campaign. In step 326, the decision module 224 of the processing server 102 may select a winning proposal by counting up the votes that were cast by the submitter 104 and the contributors 108. In some cases, the votes may be required to achieve a majority and/or must be received within a predetermined period of time for a proposal to be selected. Once the winning proposal has been selected based on the votes, then, in step 328, the campaign may be awarded to the service provider 112 that submitted the winning proposal. As part of the awarding of the campaign, the service provider 112, submitter 104, and contributors 108 may all be notified of the winning proposal. The service provider 112 may also, in step 330, receive the campaign funding through one or more transactions conducted by the transaction module 226 of the processing server 102. In some cases, the campaign funding may be awarded to the service provider 112 all at once. In other cases, the campaign funding may be awarded to the service provider 112 over time. In some instances, the campaign funding may be awarded via an initial payment to the service provider 112, as well as ongoing, recurring payments. In some instances, the campaign request and/or the service provider proposal may indicate the distribution of funding.

### Exemplary Method for Establishing an Advocacy Campaign

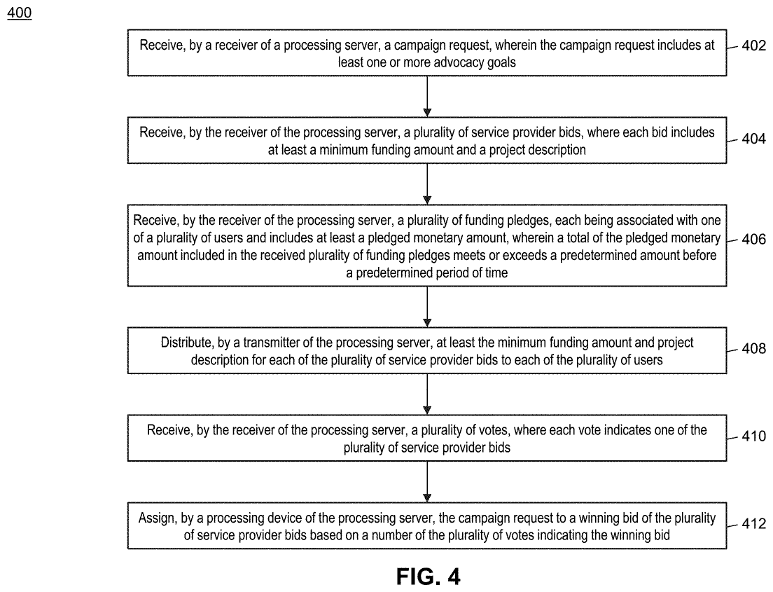

FIG. 4 illustrates a method 400 for establishing an advocacy campaign submitted by an individual to be carried out by a service provider selected from a plurality of service providers submitted bids for the campaign, where the campaign is funded through crowdfunding.

In step 402, a campaign request may be received by a receiver (e.g., the communications interface 204) of a processing server (e.g., the processing server 102), wherein the campaign request includes at least one or more advocacy goals. In step 404, a plurality of service provider bids may be received by the receiver of the processing server, where each bid includes at least a minimum funding amount and a project description.

In step 406, a plurality of funding pledges may be received by the receiver of the processing server, each being associated with one of a plurality of users (e.g., contributors 108) and includes at least a pledged monetary amount, wherein a total of the pledged monetary amount included in the received plurality of funding pledges meets or exceeds a predetermined amount before a predetermined period of time. In step 408, at least the minimum funding amount and project description for each of the plurality of service provider bids may be distributed by a transmitter (e.g., the communications interface 204) of the processing server to the plurality of users.

In step 410, a plurality of votes may be received by the receiver of the processing server, where each vote indicates one of the plurality of service provider bids. In step 412, the campaign request may be assigned to a winning bid of the plurality of service provider bids by a processing device (e.g., the processor 220) of the processing server based on a number of the plurality of votes indicating the winning bid.

In one embodiment, each vote may be submitted by one of the plurality of users. In a further embodiment, assigning of the campaign request may be further based on weighting of each of the plurality of votes according to the pledged monetary amount included in a funding pledge of the plurality of funding pledges associated with the one of the plurality of users that submitted the respective vote.

In some embodiments, the campaign request may include the predetermined amount. In one embodiment, the campaign request may include the predetermined period of time. In some embodiments, the minimum funding amount included in each of the plurality of service provider bids may meet or exceed the minimum funding amount.

In one embodiment, assigning the campaign request to the winning bid may further include initiating, by the processing device of the processing server, payment of the pledged monetary amount included in each of the plurality of funding pledges from the respective user to a service provider associated with the winning bid. In a further embodiment, each of the plurality of funding pledges may further include funding account information, each of the plurality of service provider bids may further include receiving account information, and payment of the pledged monetary amount for each of the plurality of funding pledges may be made from a funding account associated with the respective funding account information to a receiving account associated with the receiving account information corresponding to the winning service provider bid.

Techniques consistent with the present disclosure provide, among other features, systems and methods for establishing an advocacy campaign with a service provider through crowdfunding. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for establishing an advocacy campaign with a service provider through crowdfunding, comprising:
receiving, by a receiver of a processing server, a campaign request, wherein the campaign request includes at least one or more advocacy goals;
receiving, by the receiver of the processing server, a plurality of service provider bids, where each bid includes at least a minimum funding amount and a project description;
receiving, by the receiver of the processing server, a plurality of funding pledges, each being associated with one of a plurality of users and includes at least a pledged monetary amount, wherein a total of the pledged monetary amount included in the received plurality of funding pledges meets or exceeds a predetermined amount before a predetermined period of time;
distributing, by a transmitter of the processing server, at least the minimum funding amount and project description for each of the plurality of service provider bids to each of the plurality of users;
receiving, by the receiver of the processing server, a plurality of votes, where each vote indicates one of the plurality of service provider bids; and
assigning, by a processing device of the processing server, the campaign request to a winning bid of the plurality of service provider bids based on a number of the plurality of votes indicating the winning bid.

2. The method of claim 1, wherein each vote is submitted by one of the plurality of users.

3. The method of claim 2, wherein assigning of the campaign request is further based on weighting of each of the plurality of votes according to the pledged monetary amount included in a funding pledge of the plurality of funding pledges associated with the one of the plurality of users that submitted the respective vote.

4. The method of claim 1, wherein the campaign request includes the predetermined amount.

5. The method of claim 1, wherein the campaign request includes the predetermined period of time.

6. The method of claim 1, wherein the minimum funding amount included in each of the plurality of service provider bids meets or exceeds the minimum funding amount.

7. The method of claim 1, wherein assigning the campaign request to the winning bid further includes initiating, by the processing device of the processing server, payment of the pledged monetary amount included in each of the plurality of funding pledges from the respective user to a service provider associated with the winning bid.

8. The method of claim 7, wherein
each of the plurality of funding pledges further includes funding account information,
each of the plurality of service provider bids further includes receiving account information, and
payment of the pledged monetary amount for each of the plurality of funding pledges is made from a funding account associated with the respective funding account information to a receiving account associated with the receiving account information corresponding to the winning service provider bid.

9. A system for establishing an advocacy campaign with a service provider through crowdfunding, comprising:
a processing device of a processing server;
a receiver of the processing server configured to
receive a campaign request, wherein the campaign request includes at least one or more advocacy goals,
receive a plurality of service provider bids, where each bid includes at least a minimum funding amount and a project description, and
receive a plurality of funding pledges, each being associated with one of a plurality of users and includes at least a pledged monetary amount, wherein a total of the pledged monetary amount included in the received plurality of funding pledges meets or exceeds a predetermined amount before a predetermined period of time; and
a transmitter of the processing server configured to transmit at least the minimum funding amount and project description for each of the plurality of service provider bids to each of the plurality of users, wherein
the receiver of the processing server is further configured to receive a plurality of votes, where each vote indicates one of the plurality of service provider bids, and
the processing device of the processing server is configured to assign the campaign request to a winning bid of the plurality of service provider bids based on a number of the plurality of votes indicating the winning bid.

10. The system of claim 9, wherein each vote is submitted by one of the plurality of users.

11. The system of claim 10, wherein assigning of the campaign request is further based on weighting of each of the plurality of votes according to the pledged monetary amount included in a funding pledge of the plurality of funding pledges associated with the one of the plurality of users that submitted the respective vote.

12. The system of claim 9, wherein the campaign request includes the predetermined amount.

13. The system of claim 9, wherein the campaign request includes the predetermined period of time.

14. The system of claim 9, wherein the minimum funding amount included in each of the plurality of service provider bids meets or exceeds the minimum funding amount.

15. The system of claim 9, wherein assigning the campaign request to the winning bid further includes initiating, by the processing device of the processing server, payment of the pledged monetary amount included in each of the plurality of funding pledges from the respective user to a service provider associated with the winning bid.

16. The system of claim 15, wherein
each of the plurality of funding pledges further includes funding account information,
each of the plurality of service provider bids further includes receiving account information, and
payment of the pledged monetary amount for each of the plurality of funding pledges is made from a funding account associated with the respective funding account information to a receiving account associated with the receiving account information corresponding to the winning service provider bid.
